(19) United States
(12) Patent Application Publication
(10) Pub. No.: US 2025/0026650 A1
(43) Pub. Date: Jan. 23, 2025

(54) STABILIZATION PROCESS FOR THE ELECTRICAL NETWORK, THE GAS NETWORK AND/OR THE HYDROGEN NETWORK AND FOR PRODUCING AMMONIA

(71) Applicant: SAIPEM S.P.A., Milano (IT)

(72) Inventors: Matteo BERRA, Milano (IT); Lorenzo BRUNO, Milano (IT)

(21) Appl. No.: 18/714,842

(22) PCT Filed: Dec. 2, 2022
(86) PCT No.: PCT/IB2022/061702

§ 371 Date: May 30, 2024

(30) Foreign Application Priority Data
Dec. 3, 2021 (IT) 102021000030677

(51) Int. Cl. C01C 1/04; B01D 53/26; C01B 21/04; C25B 1/04

(52) U.S. Cl. CPC C01C 1/04; B01D 53/265; C01B 21/0433; B01D 2257/80; C25B 1/04

(57) ABSTRACT

A process for stabilizing an electrical network, by combining energy storage and generation steps, and for producing ammonia is provided.

### TECHNICAL FIELD OF THE INVENTION

The present invention is applicable to the energy field, and in particular, for the stabilization of the electrical network and, possibly, of the combustible gas network, as well as of the hydrogen network, normally present in a refinery.

The present invention is further applicable to the production of ammonia.

### BACKGROUND ART

Although it is known how to produce, store and consume hydrogen, there is no unitary process capable of stabilizing both the electrical network and the natural gas network or the hydrogen network (for example in a refinery) or both gas networks.

Such a process must be efficient, therefore it must have a high return coefficient of the energy withdrawn from the network, as well as practical, thus requiring limited storage spaces not linked to particular subsoil conformations, such as exhausted wells in which to store gas; moreover, it must allow the storage of amounts of energy such as to exceed the seasonality/unpredictability limits typically found in the availability of renewable energies.

It is known that the storage of large amounts of hydrogen and/or oxygen requires the liquefaction of said gases at temperatures compatible with storage at atmospheric pressure, and that said process is energetic, to the point of consuming up to one third of the calorific power of hydrogen, with the effect of limiting the production thereof per unit of available electricity.

Furthermore, while hydrogen liquefaction requires a lot of energy (the plants currently in use require an average of 11 kWh/kg), the quantity which can be returned during vaporization is much lower. In fact, considering a theoretical energy cost of 3.8 kWh/kg and a machine efficiency around 85%, no more than 3 kWh/kg can be obtained, when the vaporization is carried out at ambient pressure, and no more than 2 kWh/kg when the hydrogen is heated to the network introduction pressure.

The liquid hydrogen liquefaction and storage systems proposed so far use liquid nitrogen, but such a fluid is generated and imported from the outside, while the systems using hydrogen in the generation of electricity simply consider such a gas as available, without taking care of the recovery of the frigories if it is liquid.

In addition, the electrolytically produced hydrogen can be converted to ammonia, however using the nitrogen produced by an Air Separation Unit (ASU); the presence of oxygen in the reagents fed to the ammonia synthesis reactor, in addition to consuming hydrogen, produces water, which should then be separated, for example by distillation, from the produced ammonia.

Prior art document US 2021/340017 describes the electrolytic production of hydrogen and the subsequent sending thereof partly to ammonia synthesis reactors and partly stored after cooling, while the nitrogen, produced by cryogenic separation, is partly used for the synthesis of ammonia and partly stored for subsequent use.

Prior art documents US 2021/300759 and U.S. Pat. No. 4,107,277 describe processes for the synthesis of ammonia using a hydrogen flow obtained from water electrolysis and a nitrogen flow obtained from an Air Separation Unit (ASU).

Prior art document JP 2000002790 describes a nuclear plant which produces electricity stored in the form of liquid nitrogen and liquid oxygen by air separation, and hydrogen by electrolysis.

### SUMMARY OF THE INVENTION

The inventors of the present patent application have surprisingly found that it is possible to integrate electrolytic hydrogen production technologies with hydrogen storage technologies, both in liquid and cryo-compressed form, with the use of liquid and/or cryo-compressed nitrogen systems.

Furthermore, the capacity of ammonia to act as a storage and transport medium for hydrogen is conveniently utilized.

### OBJECT OF THE INVENTION

In a first object, the present invention describes a process for producing and storing hydrogen, and producing electricity, and for producing and storing liquid and/or cryo-compressed nitrogen, and for producing ammonia.

According to an aspect, the process of the invention comprises a first step of producing and storing hydrogen and ammonia using electricity, preferably in excess, and liquid and/or cryo-compressed nitrogen.

According to another aspect, the process of the invention comprises a second step of generating electricity, producing and storing liquid and/or cryo-compressed nitrogen and for producing ammonia.

According to a further object, a plant for carrying out the process of the invention is described.

### BRIEF DESCRIPTION OF THE DRAWINGS

FIG. 1 depicts the diagram of the storage step according to the process of the present invention.

FIG. 2 depicts the diagram of a first embodiment of the generation step according to the process of the present invention.

FIG. 3 depicts the diagram of an alternative embodiment of the generation step according to the process of the present invention.

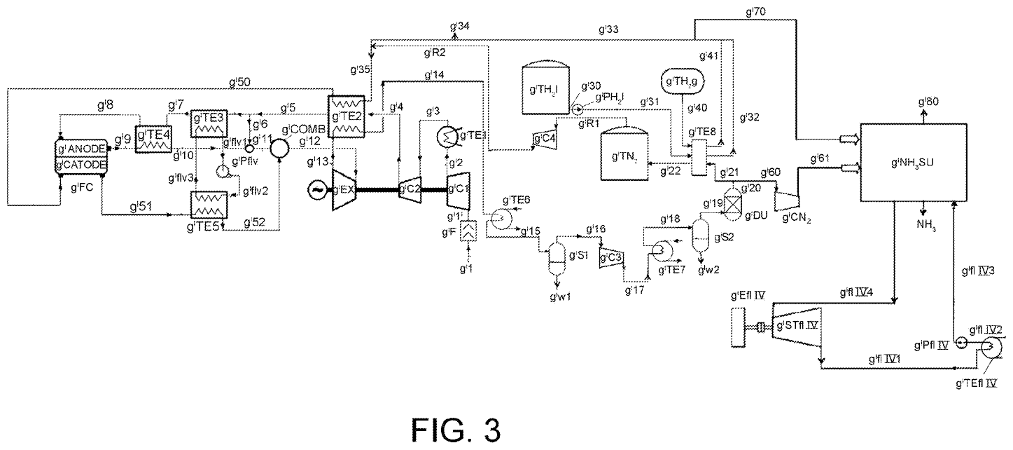

### DETAILED DESCRIPTION OF THE INVENTION

In the following description, the subscript indication “a” intends to refer to storage step A), while “g” intends to refer to generation step B); the indication “g′” refers to the alternative embodiment of the generation step (step B′).

In the following description, when referring to a nitrogen or oxygen or hydrogen flow, it is understood that such a flow has a main composition of such an element; alternatively, the indication can be in the functional sense, if the indicated element is functional to the next step or steps.

The process of the present invention comprises two steps: a first step of producing and storing liquid and/or cryo-compressed hydrogen (step A) and a second step of generating electricity and producing and storing liquid and/or cryo-compressed nitrogen (step B).

More in particular, said step A) is a step of producing and storing hydrogen and for producing ammonia.

In particular, in step A) the hydrogen is produced in liquid (H₂l) and/or gaseous (H₂g) form, in particular in cryo-compressed gaseous form.

More in particular, step A) is an energy-intensive step, as it uses electricity and, therefore, includes the consumption of electricity; therefore, it is carried out in circumstances where electricity is abundantly available.

As for step B), it is a step of producing and storing liquid and/or cryo-compressed nitrogen and producing ammonia.

In particular, in step B) nitrogen is produced in liquid (N₂l) and/or cryo-compressed form.

More in particular, in step B) the nitrogen is produced from a combusted gas flow, which, for example, can be obtained from the combustion of an air flow.

For the purposes of the present invention, step B) is further a step of producing electricity; therefore, it is carried out in circumstances where there is an increased demand for electricity or it is less available.

For the purposes of the present invention, step A) comprises using the liquid and/or cryo-compressed nitrogen produced and stored in step B).

For the purposes of the present invention, step B) comprises using the liquid and/or cryo-compressed hydrogen produced and stored in step A).

The process is described as a whole as comprising step A) and step B); said steps are alternatives to each other.

Each step will be described in greater detail below.

### Step A)

For the purposes of the present invention, step A) comprises the sub-steps of:
A1) subjecting a water flow ₐ1 to electrolysis by using electricity, thus obtaining the production of an oxygen flow ₐ2 and a hydrogen flow ₐ3,
A2) subjecting said hydrogen flow ₐ3 to a preliminary cooling step, thus obtaining a preliminarily cooled hydrogen flow ₐ4,
A3) separating a first portion ₐ40 of said preliminarily cooled hydrogen flow ₐ4 and sending it to an Ammonia Synthesis Unit ₐNH₃SU,
A4) separating a second portion ₐ5 of said preliminarily cooled hydrogen flow ₐ4 and obtaining a cooled gaseous hydrogen flow ₐ8, which is stored in a gaseous hydrogen tank ₐTH₂g,
A5) separating a third portion ₐ9 of said preliminarily cooled hydrogen flow ₐ4 and obtaining a liquid hydrogen flow ₐ17′″, which is stored in a liquid hydrogen tank ₐTH₂l.

In an aspect of the present invention, sub-step A1) is carried out in an electrolytic cell ₐEC and can use sea water; in this case, the electrolytic cell ₐEC can be provided with a purge system for the brine B.

According to a preferred aspect of the present invention, in sub-step A1) the electrolytic cell ₐEC uses electricity, preferably available in excess (therefore in circumstances where abundant electricity is available).

The term “excess electricity” means electricity produced and available in the electrical network, but which is not used.

In an aspect of the present invention, the oxygen flow ₐ2 obtained from sub-step A1) is intended for export, as a valuable by-product.

In an aspect of the present invention, prior to the preliminary cooling sub-step A2), the hydrogen flow ₐ3 obtained from sub-step A1) can be compressed in a first compressor ₐC1; therefore, sub-step A2) can be carried out on a hydrogen flow ₐ3 or on a compressed hydrogen flow ₐ3′.

For the purposes of the present invention, sub-step A3) comprises the steps of: A3a) subjecting said first portion ₐ40 of the preliminarily cooled hydrogen flow to compression in a second compressor ₐC2, thus obtaining a first portion of compressed hydrogen ₐ41.

In the Ammonia Synthesis Unit ₐNH₃SU, the first portion of compressed hydrogen ₐ41 is converted to ammonia NH₃ also using a nitrogen flow as will be described below.

For the purposes of the present invention, the synthesis of ammonia within the Ammonia Synthesis Unit ₐNH₃SU produces heat, which can be recovered by using a first working fluid circulating in a first working fluid circuit, as will be described below.

For the purposes of the present invention, sub-step A4) comprises the sub-steps of:
A4a) pre-cooling,
A4b) first cooling,
A4c) possible stabilization,
A4d) one or more further cooling operations.

For the purposes of the present invention, the pre-cooling sub-step A4a) is carried out in a second heat exchanger ₐTE2 for heat exchange with a liquid and/or cryo-compressed nitrogen flow ₐ32 at a first heating level, thus obtaining a second portion of the pre-cooled hydrogen flow ₐ6.

Possibly, such a step A4a) can also involve an additional heated refrigerant fluid ₐ51, which circulates within a circuit of an additional refrigerant fluid ₐ200, as will be described below.

For the purposes of the present invention, the first cooling sub-step A4b) is carried out in a third heat exchanger ₐTE3 for heat exchange with a pumped liquid and/or cryo-compressed nitrogen flow ₐ31, as it will be described below, obtaining a second portion of the cooled hydrogen flow ₐ7.

Possibly, such a step A4b) can also involve an additional refrigerant fluid flow ₐ50 circulating in a circuit of an additional refrigerant fluid ₐ200, as will be described below.

For the purposes of the present invention, the pre-cooling sub-step A4a) and/or the first cooling sub-step A4b) can also be carried out by heat exchange with a refrigerant fluid flow circulating in a refrigerant fluid circuit ₐ100, as will be described below.

For the purposes of the present invention, the stabilization step A4c) (as described below with reference to step A5c)) is optional (and not depicted in the figures).

For the purposes of the present invention, one and any further cooling sub-steps A4d) are carried out in a fourth ₐTE4 heat exchanger for heat exchange with a refrigerant fluid flow circulating in a refrigerant fluid circuit, as it will be described below.

From sub-step A4), a cooled gaseous hydrogen flow ₐ8 is thus obtained, which is stored in a gaseous hydrogen tank ₐTH₂g.

For the purposes of the present invention, sub-step A5) comprises the sub-steps of:
A5a) pre-cooling,
A5b) first cooling,
A5c) stabilization,
A5d) one or more further cooling operations.

For the purposes of the present invention, the pre-cooling sub-step A5a) is carried out in a second heat exchanger ₐTE2 for heat exchange with a liquid and/or cryo-compressed nitrogen flow ₐ32 at a first heating level as will be described below, thus obtaining a third portion of the pre-cooled hydrogen flow ₐ10.

Possibly, such a step A5a) can also involve an additional heated refrigerant fluid ₐ51, which circulates within a circuit of an additional refrigerant fluid ₐ200, as will be described below.

For the purposes of the present invention, the first cooling step A5b) is carried out in a third heat exchanger ₐTE3 for heat exchange with a pumped liquid and/or cryo-compressed nitrogen flow ₐ31, as it will be described below, thus obtaining a third portion of the cooled hydrogen flow ₐ11.

Possibly, such a step A5b) can also involve an additional refrigerant fluid flow ₐ50 circulating in a circuit of an additional refrigerant fluid ₐ200, as will be described below.

According to an aspect of the present invention, the third portion of the cooled hydrogen flow ₐ11 can be subjected to the stabilization sub-step A5c) for the catalytic conversion of the hydrogen from the ortho form to the para form, thus obtaining a third portion of the cooled and stabilized hydrogen flow ₐ14.

Possibly, the flow of the third portion of the cooled hydrogen flow ₐ11 can be divided into a first portion to be stabilized ₐ12′ and a second portion to be stabilized ₐ12″, each of which is subjected to the stabilization step in a respective converter ₐCONV1, ₐCONV2 obtaining a first portion of stabilized hydrogen ₐ13′ and a second portion of stabilized hydrogen ₐ13″, which can be joined in the third portion of the cooled and stabilized hydrogen flow ₐ14.

According to an aspect of the present invention, the cooled and stabilized hydrogen flow ₐ14 can be subjected to a further first cooling step A5b) in the third heat exchanger ₐTE3, thus obtaining a further cooled and stabilized hydrogen flow ₐ15.

The cooled hydrogen flow ₐ11 or the further cooled and stabilized hydrogen flow ₐ15 obtained as described above are subjected to at least one further cooling step A5d) in a fourth heat exchanger ₐTE4 and any further cooling in a fifth heat exchanger ₐTE5 and any further fifth heat exchangers ₐTE5′, ₐTE5″, ₐTE5′″, thus obtaining an even further cooled hydrogen flow ₐ16.

For the purposes of the present invention, such at least one and any further cooling steps A5d) are carried out by heat exchange with a refrigerant fluid circulating in a refrigerant fluid circuit, as it will be described below.

For the purposes of the present invention, the cooling steps can preferably be carried out in the presence of a catalyst for catalyzing the conversion of hydrogen from the ortho to the para form.

According to an aspect of the present invention, by means of such at least one and any further cooling steps, more and more cooled hydrogen flows ₐ17, ₐ17′, ₐ17″ are obtained until a liquid hydrogen flow ₐ17′″ is obtained, which is stored in a liquid hydrogen tank ₐTH₂l (normally at a temperature below −195° C.).

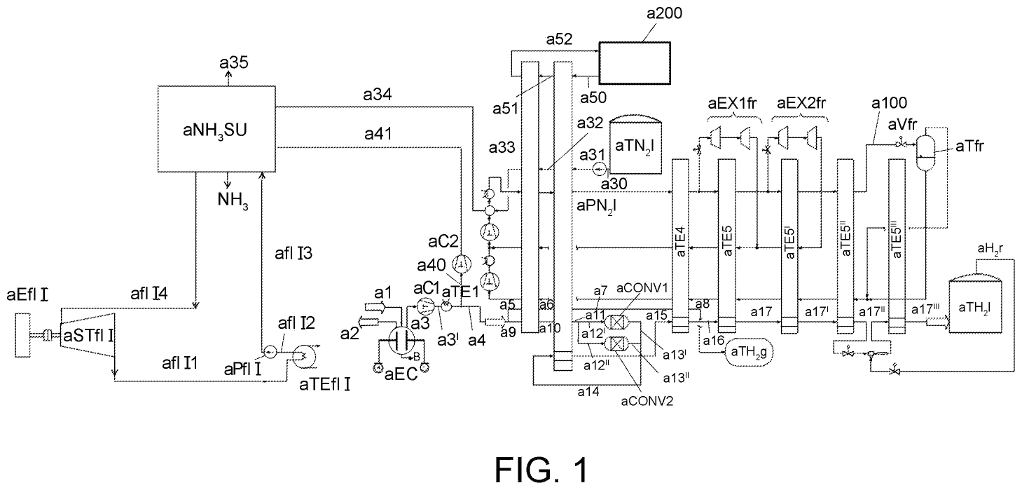

From such a tank a recirculation flow ₐH₂r can be withdrawn, which can be subjected to one of the further cooling steps A5d) (as it is diagrammatically shown in FIG. 1).

For the purposes of the present invention, the liquid nitrogen flow used in the above-described heat exchange steps (sub-steps A4a), A4b), A5a) and A5b)) is a liquid nitrogen flow withdrawn from liquid nitrogen tank ₐTN₂l (the embodiment using cryo-compressed nitrogen is contemplated by the present invention even if not depicted in the figures).

In particular, a first liquid nitrogen flow ₐ30 is obtained from said liquid nitrogen tank ₐTN₂l, which is withdrawn and pumped in a pump ₐPN₂l.

For example, up to 150 bar g can be pumped.

The pumped liquid nitrogen flow ₐ31 thus obtained is then used in the first cooling steps A4b) and A5b) obtaining a nitrogen flow at a first heating level ₐ32.

The nitrogen flow at a first heating level ₐ32 thus obtained is used in the pre-cooling steps A4a) and A5a), obtaining a liquid nitrogen flow ₐ33 at a second heating level.

For the purposes of the present invention, and as described above, the liquid nitrogen flow ₐ33 at a second heating level is sent to an Ammonia Synthesis Unit ₐNH₃SU.

According to a particular aspect, prior to this, the liquid nitrogen flow ₐ33 at a second heating level can actuate a heat exchange step with the refrigerant fluid.

The liquid nitrogen flow ₐ34 at a third heating level thus obtained or the liquid nitrogen flow ₐ33 at a second heating level are then sent to the Ammonia Synthesis Unit ₐNH₃SU, from which an ammonia flow (NH₃) is obtained.

A purge flow ₐ35 released into the atmosphere is also obtained from the Ammonia Synthesis Unit ₐNH₃SU.

Refrigerant fluid circuit For the purposes of the present invention, the fluid circulating in the refrigerant fluid circuit ₐ100 can be represented by hydrogen or helium and it is preferably represented by hydrogen.

The refrigerant fluid circuit does not represent a limiting element of the present invention, as it is sufficient that it allows cooling the first ₐ5 and the third ₐ9 portions of the preliminarily cooled hydrogen flow as described above.

According to an embodiment of the present invention, for example depicted in FIG. 1, such a circuit ₐ100 can operate according to the Claude cycle.

Such a cycle includes at least three expansion steps of the refrigerant fluid contained in a tank ₐTfr, of which two expansion steps are obtained by means of a first and a second expander ₐEX1_{fr}, ₐEX2_{fr} and the third expansion step by means of a valve ₐV_{fr}.

After being withdrawn from the tank ₐT_{fr}, the refrigerant fluid flow therefore carries out the heat exchange steps:
A4d) and A5d) of at least one and optionally further cooling steps,
A4b) and A5b) of first cooling, and
A4a) and A5a) of pre-cooling.

The above steps can be carried out in countercurrent or in co-current and can possibly be repeated, in the same direction or not.

As for the expansion steps, each expansion follows a possible further heat exchange step with the hydrogen flow of steps A4d) and A5d).

Additional refrigerant fluid circuit For the purposes of the present invention and as described above, an additional refrigerant fluid circuit ₐ200 can be included.

Such a fluid circulates in a circuit from which an additional refrigerant fluid flow ₐ50 originates, which can be involved in step A4b) and/or A5b) (described above), thus obtaining a heated additional refrigerant fluid flow ₐ51.

In turn, such a heated additional refrigerant fluid flow ₐ51 can also be involved in step A4a) and/or A5a) (described above), thus obtaining a further heated additional refrigerant fluid flow ₐ52, which recirculates in the circuit ₐ200.

For the purposes of the present invention, the additional refrigerant fluid can be represented, for example, by nitrogen, ammonia, propane, ethylene.

First Working Fluid Circuit (flI)

As described above, the heat produced by the synthesis of ammonia is recovered by using a first working fluid.

A first flow of the first working fluid ₐflI1 is first condensed in a heat exchanger of the first working fluid ₐTEflI by an external refrigerant fluid, thus obtaining a cooled flow ₐflI2, which is pumped by a pump of the first working fluid ₐPflI, thus obtaining a pumped first working fluid flow ₐflI3.

Said pumped flow ₐflI3 acquires heat from the Ammonia Synthesis Unit ₐNH₃SU by vaporizing, thus obtaining a heated flow ₐflI4, which is expanded in a steam turbine ₐSTflI, which, by virtue of a generator ₐEflI, produces electricity.

The expanded flow thus obtained is the first flow of the first working fluid ₐflI1 which is sent to the exchanger ₐTEflI.

For the purposes of the present invention, the first working fluid ₐfll can be represented by water or air and is preferably represented by water.

For the purposes of the present invention, the above condensation is obtained by heat exchange with an external refrigerant fluid.

Such an external refrigerant fluid can be represented by water or air and is preferably represented by water.

### Step B)

For the purposes of the present invention, step B) comprises the sub-steps of:
B1) subjecting an air flow _{g}1 to combustion in the presence of a hydrogen flow _{g}33, thus obtaining a combusted gas flow _{g}3,
B2) expanding said combusted gas flow _{g}3, thus obtaining an expanded combusted gas flow _{g}4,
B3) subjecting said expanded combusted gas flow _{g}4 to a first cooling, thus obtaining an expanded combusted gas flow _{g}5 at a first cooling level,
B4) separating a portion _{g}40 from said expanded combusted gas flow _{g}5 at a first cooling level and sending it to an Ammonia Synthesis Unit _{g}NH₃SU for the synthesis of ammonia NH₃,
B5) subjecting said expanded combusted gas flow _{g}5 at a first cooling level to a second cooling step, thus obtaining an expanded gas flow _{g}6 at a second cooling level,
B6) subjecting said expanded gas flow _{g}6 at a second cooling level to a water separation step, thus obtaining a dehydrated combusted gas flow _{g}7,
B7) possibly separating a first recirculation portion _{g}8 from said dehydrated combusted gas flow _{g}7, which is joined to the air flow _{g}1 of sub-step B1),
B8) subjecting a second portion _{g}9 separated from said dehydrated combusted gas flow _{g}7 to compression, obtaining a compressed dehydrated combusted gas flow _{g}10,
B9) subjecting said compressed dehydrated combusted gas flow _{g}10 to cooling and at least one water separation step, obtaining a nitrogen flow _{g}13,
B10) subjecting said nitrogen flow _{g}13 to condensation, thus obtaining a liquid nitrogen flow _{g}14, which is sent to a liquid nitrogen tank _{g}TN₂l.

For the purposes of the present invention, the pre-cooling of sub-step A4a) and the pre-cooling of sub-step A5a) are carried out using the liquid nitrogen flow obtained and stored in sub-step B10).

According to an aspect of the present invention, the cooling of sub-step A4b) and the cooling of sub-step A5b) are also carried out using the liquid nitrogen flow obtained and stored in sub-step B10).

With reference to sub-step B1), this is carried out in a combustor _{g}COMB.

For the purposes of the present invention, sub-step B1) can be carried out on an air flow _{g}1 preliminarily subjected to filtration by means of a filter _{g}F, thus obtaining a filtered air flow _{g}1′.

In another aspect of the present invention, the air flow _{g}1 or the filtered air flow _{g}1′ is compressed in a compressor _{g}TC, thus obtaining a compressed air flow _{g}2.

Therefore, the combustion of sub-step B1) can be carried out on an air flow g1 or filtered air flow _{g}1′ or on a compressed air flow _{g}2.

For the purposes of the present invention, sub-step B1) can be carried out in the combustor _{g}COMB even in the presence of a compressed flow of non-condensables _{g}R2 as described below.

In a particular aspect of the invention, the air flow _{g}1, possibly filtered _{g}1′ and/or compressed _{g}2, is joined to the recirculating flow _{g}8 according to sub-step B7) described above.

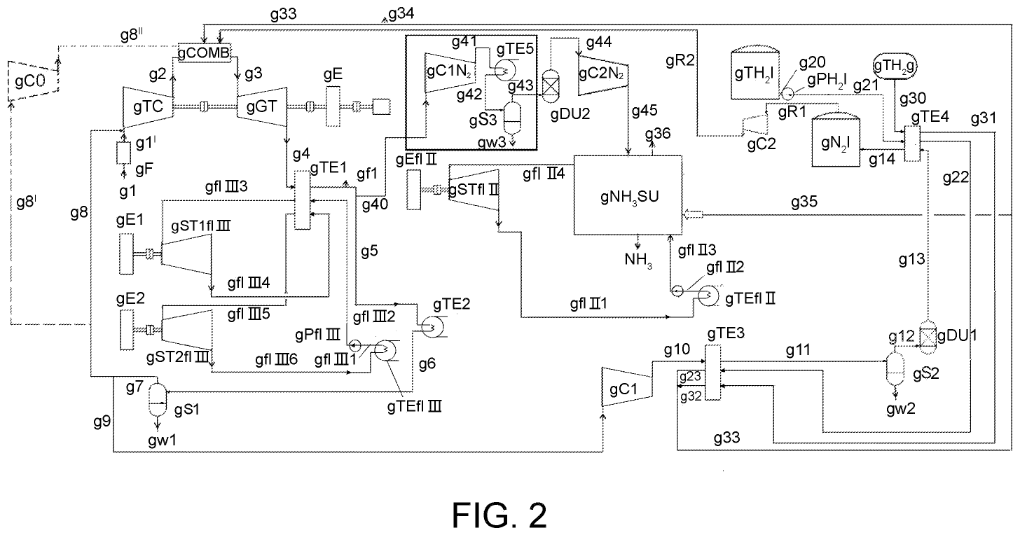

In an alternative aspect of the present invention as shown in FIG. 2, if linked to technical needs of the process or of the combustor, a portion _{g}8′ of the recirculating flow _{g}8 can be sent, instead of being suctioned to the compressor _{g}TC, in whole or partially, directly to the combustor _{g}COMB, as a dilution gas, after compression in a compressor _{g}C0, obtaining a compressed recirculating flow g8″.

Advantageously, such a recirculating flow _{g}8 and such a further recirculating flow _{g}8″ have the effect of moderating the combustion temperature of sub-step B1), which is normally between 900-1,800° C. and preferably is around 1,500° C., avoiding the use of complex cooling systems; furthermore, it allows achieving an optimal volumetric flow for the use of a compressor and the gas turbine of the next step.

For the purposes of the present invention, the combustion of sub-step B1) is carried out in the presence of an overall vaporized hydrogen flow _{g}33 obtained as will be described below.

Water and heated combusted gases are obtained with the combustion of sub-step B1), which are generally referred to with a combusted gas flow _{g}3.

In an aspect of the present invention, the expansion sub-step B2) is carried out in a gas turbine _{g}GT with mechanical energy production which, by virtue of a generator _{g}E, produces electricity.

In an aspect of the present invention, the first cooling sub-step B3) of the combusted gases _{g}4 is carried out in a first heat exchanger _{g}TE1 by a third working fluid _{g}flIII, circulating in a third working fluid circuit, as described below.

In a preferred aspect, after the cooling sub-step B3), a portion of the flow _{g}f1 can be released into the atmosphere.

In an aspect of the present invention, the second cooling sub-step B5) is carried out in a second heat exchanger _{g}TE2 by an external refrigerant fluid.

Such an external refrigerant fluid can be represented by water or air at ambient temperature and is preferably represented by water.

As for sub-step B6), this comprises separating a first portion of condensed water _{g}w1 from the bottom of a first separator _{g}S1.

The first dehydrated flow obtained _{g}7 is then divided into a first portion _{g}8, representing the recirculating flow to the compressor _{g}TC and into a second portion _{g}9, which is sent to the compressor _{g}C1 for sub-step B8).

For the purposes of the present invention, the compression sub-step B8) is carried out in a first compressor _{g}C1, thus obtaining a compressed dehydrated gas flow _{g}10.

In an aspect of the present invention, the cooling of sub-step B9) is carried out in a third heat exchanger _{g}TE3 and is obtained by heat exchange with a heated gaseous hydrogen flow _{g}31 and/or with a heated vaporized hydrogen flow _{g}22 as described below, thus obtaining a dehydrated and compressed gas flow _{g}11.

The at least one water separation step is carried out on said dehydrated and compressed gas flow _{g}11 in a second separator _{g}S2, thus obtaining a second portion of condensed water _{g}w2 and a further dehydrated and compressed gas flow _{g}12.

A further dehydration step can be carried out on said further dehydrated and compressed gas flow _{g}12 in a first dehydration unit _{g}DU1 by molecular sieves, thus obtaining a nitrogen flow _{g}13.

In a preferred aspect, such a dehydration is carried out until reducing the water content below 500 ppm and preferably below 50 ppm.

For the purposes of the present invention, the cooling sub-step B10) is a condensing step carried out in a fourth exchanger _{g}TE4 for heat exchange with a gaseous hydrogen flow _{g}30 and with a pumped liquid hydrogen flow _{g}21.

In particular, such a gaseous hydrogen flow _{g}30 is obtained from a gaseous hydrogen tank _{g}TH₂g.

In particular, such a pumped liquid hydrogen flow _{g}21 is obtained from a liquid hydrogen flow _{g}20 obtained from a liquid hydrogen tank _{g}TH₂l pumped by a liquid hydrogen pump _{g}PH₂l.

The liquid nitrogen flow _{g}14 thus obtained is stored in a liquid nitrogen tank gTN₂l.

A flow of non-condensables _{g}R1 can develop from such a tank gTN₂l, and can be sent to a second compressor _{g}C2, thus obtaining a compressed flow of non-condensables _{g}R2 consisting mainly of hydrogen, oxygen and nitrogen, which, as described above, can be recirculated to the combustor _{g}COMB for sub-step B1).

For the purposes of the present invention, the pre-cooling of sub-step A4a) is carried out by using the liquid nitrogen flow obtained in sub-step B10).

According to an aspect of the present invention, the pre-cooling sub-step A5a) can also be carried out by using the liquid nitrogen flow obtained in sub-step B10).

For the purposes of the present invention, the gaseous hydrogen stored in the gaseous hydrogen tank _{g}TH₂g and the liquid hydrogen stored in the liquid hydrogen tank _{g}TH₂l are obtained by steps A4) and A5) of the storage step A) described above, respectively; therefore, the tanks ₐTH₂g and _{g}TH₂g coincide with each other, as well as the tanks ₐTH₂l and _{g}TH₂l.

For the purposes of the present invention, after sub-step B10) the heated gaseous hydrogen flow _{g}31 and/or the heated vaporized hydrogen flow _{g}22 are both sent to the cooling sub-step B9) in the third exchanger _{g}TE3, thus obtaining a vaporized heated hydrogen flow _{g}32 and a further vaporized heated hydrogen flow _{g}23, which are joined in an overall vaporized hydrogen flow _{g}33.

Such an overall vaporized hydrogen flow g33 is sent to the combustor _{g}COMB for sub-step B1), possibly after having drained a portion _{g}34, which can be sent to the natural gas network or to the hydrogen network of a refinery.

As described above, in step B4) a portion of the expanded combusted gases _{g}40 at a first cooling level is separated, which is sent to an Ammonia Synthesis Unit _{g}NH₃SU.

Before being involved in the synthesis of ammonia NH₃, such a portion _{g}40 is subjected to one or more compression and cooling cycles for the separation of the condensed water and is subjected to compression.

Therefore, for this purpose, such a portion _{g}40 is subjected to the steps:
B4a) of compression in a first nitrogen compressor _{g}C1N₂, thus obtaining a first compressed portion _{g}41,
B4b) of cooling in a fifth heat exchanger _{g}TE5, thus obtaining a compressed and cooled portion of the nitrogen flow _{g}42,
B4c) of separating a third portion of the condensed water _{g}w3 in a third separator _{g}S3, thus obtaining a portion of dehydrated nitrogen flow _{g}43,
B4d) of further dehydration in a second Dehydration Unit _{g}DU2 by means of appropriate molecular sieves, thus obtaining a portion of the further dehydrated nitrogen flow _{g}44,
B4e) of compressing the portion of the further dehydrated nitrogen flow _{g}44 in a second nitrogen compressor _{g}C2N₂, thus obtaining a synthesis nitrogen flow _{g}45.

For the purposes of the present invention, each of steps B4a) to B4c) are repeated one or more times until the desired dehydration level is obtained.

For the purposes of the present invention, a portion of synthesis hydrogen _{g}35 is separated from the overall vaporized hydrogen flow _{g}33 and sent to the Ammonia Synthesis Unit _{g}NH₃SU for the synthesis of ammonia NH₃.

The synthesis nitrogen flow _{g}45 and the portion of synthesis hydrogen _{g}35 are then sent to the Ammonia Synthesis Unit.

A purge flow ₐ36 released into the atmosphere is also obtained from the Ammonia Synthesis Unit _{g}NH₃SU.

For the purposes of the present invention, the synthesis of ammonia within the Ammonia Synthesis Unit _{g}NH₃SU produces heat, which can be recovered by using a second working fluid circulating in a second working fluid circuit, as will be described below.

Third Working Fluid Circuit (flIII)

For the purposes of the present invention, the first cooling of sub-step B3) is obtained with a third working fluid which is selected from the group comprising air and water and is preferably represented by water.

After the first-cooling heat exchange step B3) in a first exchanger _{g}TE1, the third flow of the third heated working fluid _{g}flIII3 thus obtained is expanded in a steam turbine _{g}ST1flIII, thus obtaining an expanded flow _{g}flIII4; since such a turbine is connected to a first generator _{g}E1, electricity can be produced.

The thus obtained expanded flow _{g}flIII4 is further heated in the first heat exchanger _{g}TE1, giving a heated flow of the third working fluid _{g}flIII5, which is subjected to a second expansion in a second expansion turbine _{g}ST2flIII; since this is connected to a second generator _{g}E2, electricity can be produced.

The further expanded flow of the second working fluid _{g}flIII6 thus obtained is cooled in the exchanger of the third working fluid _{g}TEflIII by using an external refrigerant fluid, thus obtaining a cooled flow _{g}flIII1, which is pumped in a pump of the third working fluid _{g}PflIII, thus obtaining a pumped flow _{g}flIII2, which is used in the heat exchange step B3).

Such an external refrigerant fluid can be represented by water or air and is preferably represented by water.

Second Working Fluid Circuit (flII)

As described above, the heat produced by the synthesis of ammonia is recovered by using a second working fluid.

A first flow of the second working fluid _{g}flII1 is first condensed in a heat exchanger of the second working fluid _{g}TEflII by an external refrigerant fluid, thus obtaining a cooled flow _{g}flII2, which is pumped by a pump of the second working fluid _{g}PflII, thus obtaining a pumped second working fluid flow _{g}flII3.

Said pumped flow _{g}fllII3 acquires heat from the Ammonia Synthesis Unit _{g}NH₃SU by vaporizing, thus obtaining a heated flow gfllII4, which is expanded in a steam turbine gSTflII, which, by virtue of a generator gEflII, produces electricity.

The expanded flow thus obtained is the first flow of the second working fluid _{g}flII1 which is sent to the exchanger gTEflII.

For the purposes of the present invention, the second working fluid flII can be represented by water or air and is preferably represented by water.

For the purposes of the present invention, the above condensation is obtained by heat exchange with an external refrigerant fluid.

Such an external refrigerant fluid can be represented by water or air and is preferably represented by water.

In accordance with an alternative embodiment, the generation step B) according to the present invention is a step B′) comprising the use of a fuel cell g′FC for producing electricity.

According to such an embodiment, the air flow _{g′}1 to be subjected to combustion in the combustor _{g′}COMB according to step B′1) is preliminarily subjected to a treatment comprising the following sub-steps:
b0) if necessary, filtering by means of a filter _{g′}F, thus obtaining a filtered air flow _{g′}1′,
b1) compressing, obtaining a compressed air flow _{g′}4,
b2) heating and obtaining a compressed and further heated air flow _{g′}8,
b3) reducing the oxygen contained in said compressed and further heated air flow _{g′}8, thus obtaining a reduced flow _{g′}9,
b4) cooling, thus obtaining a cooled reduced flow _{g′}10 and joining to a heated integration flow _{g′}6.

For the purposes of the present invention, the compression sub-step b1) can subject the air flow _{g′}1 or filtered air flow _{g′}1′ to the sub-steps of:
b1a) first compression in a first compressor _{g′}C1, thus obtaining a flow at a first compression level _{g′}2,
b1b) cooling in a first heat exchanger _{g′}TE1, thus obtaining a flow at a first cooled compression level _{g′}3, and
b1c) second compression in a second compressor _{g′}C2, thus obtaining the compressed flow _{g′}4.

In particular, sub-step b1b) of cooling in a first heat exchanger g TE1 is obtained by heat exchange with a fluid selected between air and water.

As for sub-step b2), this comprises three heating steps, in which:
sub-step b2a) is obtained by heat exchange in a second exchanger _{g′}TE2 with an expanded fluid flow _{g′}13 as described below, thus obtaining a first heating flow _{g′}5,
sub-step b2b) is obtained by heat exchange in a third exchanger _{g′}TE3 with a fifth working fluid, for example represented by nitrogen, thus obtaining a heated compressed air flow _{g′}7, and
sub-step b2c) is obtained by heat exchange in a fourth exchanger _{g′}TE4, thus obtaining a compressed and further heated air flow _{g′}8, where such a heat exchange is carried out with the reduced flow _{g′}9 output from the anode.

For the purposes of the present invention, after sub-step b2a) of heat exchange in a second exchanger _{g′}TE2, a heated integration flow _{g′}6 is separated, which is joined to the cooled reduced flow _{g′}10, thus obtaining an integrated flow _{g′}11 sent to the combustor _{g′}COMB for sub-step B′1).

As for sub-step b3) of oxygen reduction, this is obtained in the anode of a fuel cell g′FC, thus obtaining the reduction of oxygen and the formation of a reduced flow _{g′}9.

The thus obtained reduced flow _{g′}9 is cooled in sub-step b4) by the heat exchange described above with reference to sub-step b2c).

According to the alternative embodiment of the present invention, an overall vaporized hydrogen flow _{g′}33 is sent to the combustor _{g′}COMB for the combustion of sub-step B′1).

In particular, such a hydrogen flow is an overall vaporized hydrogen flow _{g′}33 obtained by joining a heated gaseous hydrogen flow _{g′}41 and/or a pumped and heated gaseous hydrogen flow _{g′}32, as described below.

A release portion _{g′}34 released into the atmosphere can be separated from the overall vaporized hydrogen flow _{g′}33.

Furthermore, for the purposes of the present invention, a non-condensables flow _{g′}R2 consisting mainly of hydrogen, oxygen and nitrogen, obtained as described below, can be joined with such an overall vaporized hydrogen flow _{g′}33, giving a flow to send to the combustor _{g′}COMB for combustion _{g′}35.

For the purposes of the present invention, such flows of heated gaseous hydrogen _{g′}41 and pumped and heated gaseous hydrogen _{g′}32 are obtained from the respective tanks _{g′}TH₂g and _{g′}TH₂l, in which they are stored after the storage sub-steps A4) and A5) described above with reference to step A); therefore, the tanks ₐTH₂g and _{g′}TH₂g coincide with each other, as well as the tanks ₐTH₂l and _{g′}TH₂l.

For the purposes of the present invention, a portion _{g′}70 which is sent to the Ammonia Synthesis Unit _{g′}NH₃SU as described below is separated from the overall vaporized hydrogen flow _{g′}33.

For the purposes of the present invention, before being sent to the combustor _{g′}COMB for sub-step B′1), such a flow to be sent to the combustor _{g′}35 is subjected to the steps of:
b′1) heating, obtaining a heated flow _{g′}50 to be oxidized,
b′2) oxidizing the hydrogen, thus obtaining an oxidized flow _{g′}51,
b′3) further cooling, thus obtaining a cooled oxidized flow _{g′}52.

In particular, the heating sub-step b′1) is obtained in the first heat exchanger _{g′}TE2 for heat exchange with the expanded combusted gas flow _{g′}13.

For the purposes of the present invention, the heating step b′1) is carried out in the same exchanger as sub-step b2a).

As for sub-step b′2), this is obtained in the cathode of a fuel cell g′FC and, in particular, in the same fuel cell of sub-step b3).

The further cooling sub-step b′3) is carried out in a fifth heat exchanger _{g′}TE5 for heat exchange with a second flow of a fifth working fluid _{g′}flv2 for example represented by nitrogen, circulating in a fifth working fluid circuit, as described below.

In particular, a third flow of a fifth working fluid _{g′}flv3 carries out the heat exchange in the third heat exchanger g TE3, thus obtaining a first flow of the fifth working fluid _{g′}flv1, which is pumped by a pump of the fifth working fluid _{g′}Pflv, thus obtaining the second flow of the fifth working fluid _{g′}flv2 above.

In an aspect of the present invention, said third flow of the fifth working fluid _{g′}flv3 is the flow involved in the heat exchange of sub-step b2b).

According to the alternative embodiment described above, a combusted gas flow _{g′}12 is obtained from the combustion step B′1), which is subjected to the further steps of:
B′2) expanding said combusted gas flow _{g′}12 in an expander _{g′}EX, thus obtaining an expanded combustion flue gas flow _{g′}13,
B′3) cooling said expanded combusted gas flow _{g′}13, thus obtaining a cooled expanded combusted gas flow _{g′}15,
B′4) separating the water and obtaining a nitrogen flow _{g′}20,
B′5) separating a first portion of said nitrogen flow _{g′}21 and subjecting it to cooling in an eighth heat exchanger _{g′}TE8, thus obtaining a liquid nitrogen flow _{g′}22,
B′6) sending a second portion of said nitrogen flow _{g′}60 to an Ammonia Synthesis Unit _{g′}NH₃SU for the synthesis of ammonia.

The liquid nitrogen flow _{g′}22 is then stored in a liquid nitrogen tank _{g′}TN₂l.

A flow of non-condensables _{g′}R1 can develop from such a tank _{g′}TN₂l, which can be sent to a fourth compressor _{g′}C4, thus obtaining a compressed flow of non-condensables _{g′}R2 consisting mainly of hydrogen, oxygen and nitrogen, which, as described above, can be recirculated to the combustor _{g′}COMB for the combustion step B′1).

For the purposes of the present invention, sub-step B′3) comprises the further sub-steps of:
B′3a) cooling said expanded combusted gas flow _{g′}13 in the second heat exchanger _{g′}TE2, thus obtaining a first cooled flow _{g′}14, and
B′3b) cooling said first cooled flow _{g′}14 in a sixth heat exchanger _{g′}TE6, thus obtaining said expanded and cooled combusted gas flow _{g′}15.

For the purposes of the present invention, said sub-step B′4) comprises the further sub-steps of:
B′4a) subjecting said expanded and cooled combusted gas flow _{g′}15 to a first water separation _{g′}w1 in a first separator _{g′}S1, thus obtaining a dehydrated combusted gas flow _{g′}16,
B′4b) compressing said dehydrated combusted gas flow _{g′}16 in a third compressor _{g′}C3 obtaining a compressed dehydrated combusted gas flow _{g′}17,
B′4c) cooling said compressed dehydrated combusted gas flow _{g′}17 in a seventh heat exchanger _{g′}TE7, thus obtaining a compressed and cooled dehydrated combusted gas flow _{g′}18 by heat exchange with an external refrigerant fluid;
B′4d) subjecting said flow to a second water separation _{g′}w2 in a second separator _{g′}S2, thus obtaining a further dehydrated combusted gas flow _{g′}9,
B′4e) subjecting the flow thus obtained to further dehydration in a dehydration unit _{g′}DU, thus obtaining the nitrogen flow _{g′}20.

In a preferred aspect, such a dehydration is carried out until reducing the water content below 500 ppm and preferably below 50 ppm.

According to the alternative embodiment of the present invention, sub-step B′5) is carried out by heat exchange with the gaseous hydrogen flow _{g′}40 and/or with the pumped liquid hydrogen flow _{g′}31.

In particular, said pumped liquid hydrogen flow _{g′}31 is obtained by pumping with a liquid hydrogen pump _{g′}PH₂l a liquid hydrogen flow _{g′}30 obtained from the liquid hydrogen tank _{g′}TH₂l.

As for step B′6), before sending to the Ammonia Synthesis Unit _{g′}NH₃SU, the second portion of nitrogen _{g′}60 is compressed in a nitrogen compressor _{g′}CN₂, thus obtaining a compressed nitrogen flow _{g′}61.

The synthesis of ammonia NH₃ is thus obtained from the nitrogen flow _{g′}61 and the hydrogen flow _{g′}70.

Ammonia NH₃ and a purge flow _{g′}80 released into the atmosphere, containing nitrogen, argon, hydrogen and oxygen, in varying amounts, is obtained from the Ammonia Synthesis Unit _{g′}NH₃SU.

For the purposes of the present invention, the synthesis of ammonia within the Ammonia Synthesis Unit _{g′}NH₃SU produces heat, which can be recovered by using a fourth working fluid fllV circulating in a fourth working fluid circuit, as will be described below.

Fourth Working Fluid Circuit (flIV)

A first flow _{g′}flIV1 is first condensed in a heat exchanger of the fourth working fluid _{g′}TEflIV by an external refrigerant fluid, thus obtaining a cooled flow _{g′}flIV2, which is pumped by a pump of the fourth working fluid _{g′}PflIV, thus obtaining a pumped flow of the fourth working fluid _{g′}flIV3.

Said pumped flow _{g′}flIV3 acquires heat from the Ammonia Synthesis Unit _{g′}NH₃SU by vaporizing, thus obtaining a heated flow of the fourth working fluid _{g′}flIV4, which is expanded in a steam turbine _{g′}STflIV, which, by virtue of a generator _{g′}EflIV, produces electricity.

The expanded flow thus obtained is the first flow of the fourth working fluid _{g′}fllV1 which is sent to the exchanger g TEflIV.

For the purposes of the present invention, the fourth working fluid can be represented by water or air and is preferably represented by water.

For the purposes of the present invention, the external refrigerant fluids may be represented by water or air at room temperature and are preferably represented by water.

As described above, for the purposes of the present invention, the liquid and gaseous or cryo-compressed hydrogen tanks of the storage step and the generation step coincide.

More generally, in the present description, the following coincide with each other:
the tanks ₐTH₂g, _{g}TH₂g and _{g′}TH₂g, and
the tanks ₐTH₂l, _{g}TH₂ₗ and _{g′}TH₂l.

As described above, the liquid or cryo-compressed nitrogen tanks of the storage step and the generation step also coincide; therefore:
the following tanks coincide: ₐTN₂l, _{g}TN₂l and _{g′}TN₂l.

Similarly, the Ammonia Synthesis Units of the storage step and the generation step coincide (respectively: ₐNH₃SU, _{g}NH₃SU and _{g′}NH₃SU), as do the first, second and fourth working fluids and the respective cycles described above (ₐflI, _{g}flII and _{g′}flIV).

In accordance with a further object, a plant for carrying out the above-described process of the invention is described.

In particular, such a plant comprises: a liquid and/or cryo-compressed nitrogen tank ₐTN₂l, gTN₂l, _{g′}TN₂l, a liquid hydrogen tank ₐTH₂l, _{g}TH₂l, _{g′}TH₂l, a gaseous hydrogen tank ₐTH₂g, _{g}TH₂g, _{g′}TH₂g, an Ammonia Synthesis Unit ₐNH₃SU, _{g}NH₃SU, _{g′}NH₃SU for the synthesis of ammonia with a working fluid circuit, an air compressor _{g}TC, _{g′}TC1, _{g′}TC2, a combustor for subjecting an air flow to combustion _{g}COMB, _{g′}COMB, a gas turbine _{g}GT with a generator _{g}E or an expander _{g′}EX for generating electricity and possibly a further turbine in the working fluid circuit of the Ammonia Synthesis Unit _{g}STflII, _{g′}STflIV connected to a generator for further generating electricity, and heat exchangers ₐTE2, ₐTE3, _{g}TE4, _{g′}TE8 for the heat exchange between a liquid nitrogen flow and a liquid and gaseous and/or cryo-compressed hydrogen flow.

Therefore, for the purposes of the present invention, the liquid nitrogen flow withdrawn from said liquid and/or cryo-compressed nitrogen tank ₐTN₂l, _{g}TN₂l, _{g′}TN₂l is intended for said Ammonia Synthesis Unit ₐNH₃SU, _{g}NH₃SU, _{g′}NH₃SU after the heat exchange mentioned above, while after said heat exchange the liquid and/or gaseous hydrogen flow is intended for said liquid hydrogen tank ₐTH₂l, _{g}TH₂l, _{g′}TH₂l or gaseous hydrogen tank ₐTH₂g, _{g}TH₂g, _{g′}TH₂g; or the liquid and/or gaseous hydrogen flow obtained from said liquid hydrogen tank ₐTH₂l, _{g}TH₂l, _{g′}TH₂l or gaseous hydrogen tank ₐTH₂g, _{g}TH₂g, _{g}TH₂g is intended for said Ammonia Synthesis Unit ₐNH₃SU, _{g}NH₃SU, _{g′}NH₃SU after the heat exchange mentioned above, together with a nitrogen flow obtained from a combusted gas flow obtained from said combustor _{g}COMB, _{g′}COMB, while the liquid nitrogen flow obtained after said heat exchange is intended for said liquid and/or cryo-compressed nitrogen tank ₐTN₂l, _{g}TN₂l, _{g′}TN₂l.

According to an aspect of the present invention, a fuel cell _{g′}FC for the further production of electricity can be further comprised.

According to a particular aspect of the present invention, the plant is that which carries out the process as described above.

From the description provided above, the advantages offered by the present invention will be apparent to those skilled in the art.

The present invention allows integrating electrolytic hydrogen production technologies with hydrogen storage technologies, both in gaseous and cryo-compressed form, with the use of a gas turbine or an electrolytic cell, which can produce electricity and nitrogen, with a hydrogen frigories recovery system and an ammonia production system.

Therefore, the process described allows:
stabilizing the electrical network, by virtue of the absorption of excess energy or by feeding energy into the network;
stabilizing the combustible gas network,
stabilizing the hydrogen network, because it is capable of producing hydrogen to be fed into the natural gas network or the hydrogen network, for example inside a refinery.

The described process can further be used for producing gaseous oxygen, even at high pressure, to be used for other purposes.

The described process advantageously does not release carbon dioxide into the environment.

Furthermore, it does not require an air separation unit (ASU) to produce liquid nitrogen to be stored and uses widely available and technologically “mature” technologies such as gas turbines.

The described process is capable of producing liquid ammonia continuously, overcoming the difficulties related to discontinuous operations of the ammonia reactor.

In the embodiment which applies sea water electrolysis, the described process can also be used to desalinate water, producing discrete amounts thereof as a by-product.

The use of gaseous hydrogen and liquid hydrogen allows optimally balancing the requirements of not having to bear excessive costs for storing hydrogen as a cryo-compressed gas, avoiding the (economic and logistical) problem of having metal containers suitable for storage.

Furthermore, while storage in gaseous form is normally used for a short period, for example daily, storage in liquid form is ideal in the long term; this allows adapting the process to specific needs, for example seasonal needs.

According to particular applications of the present invention, the electricity used in the storage step can be excess electricity absorbed from the network.

For example, it can be energy from renewable sources, such as photovoltaic energy, which, by its nature, has a daily and seasonal trend.

1. A process for producing and storing hydrogen in liquid and/or gaseous form and for producing ammonia in a step A) and, in a step B), for producing electricity and for producing and storing liquid and/or cryo-compressed nitrogen and ammonia, wherein said step A) comprises using the liquid and/or cryo-compressed nitrogen produced and stored in step B) from a combusted gas flow and wherein step B) comprises using the use-of hydrogen in liquid and/or gaseous form produced and stored in step A).

2. The process of claim 1, wherein in step A) and in step B) a heat exchange step is carried out between a flow of said hydrogen and a flow of said nitrogen.

3. The process of claim 1, wherein said electricity is at least partially produced in a fuel cell.

4. The process of claim 1, wherein step A) comprises sub-steps of:
A1) subjecting a water flow to electrolysis by using electricity, thus obtaining an oxygen flow and a hydrogen flow,
A2) subjecting said hydrogen flow to a preliminary cooling step, thus obtaining a preliminarily cooled hydrogen flow,
A3) separating a first portion of said preliminarily cooled hydrogen flow and sending it to an ammonia synthesis unit for the synthesis of ammonia,
A4) separating a second portion of said preliminarily cooled hydrogen flow and obtaining a cooled gaseous hydrogen flow, which is stored in a gaseous hydrogen tank, and
A5) separating a third portion of said preliminarily cooled hydrogen flow and obtaining a liquid hydrogen flow, which is stored in a liquid hydrogen tank.

5. The process of claim 4, wherein sub-step A4) comprises sub-sub-steps of:
A4a) pre-cooling,
A4b) first cooling,
A4c) possible stabilization, and
A4d) one or more further cooling sub-sub-steps, thus obtaining said cooled gaseous hydrogen flow.

6. The process of claim 4, wherein sub-step A5) comprises sub-sub-steps of:
A5a) pre-cooling,
A5b) first cooling,
A5c) stabilization, and
A5d) one or more further cooling sub-sub-steps, thus obtaining said liquid hydrogen flow.

7. The process of claim 6, wherein sub-sub-step A4a) and sub-sub-step A5a) of pre-cooling are carried out by heat exchange with a liquid and/or cryo-compressed nitrogen flow at a first heating level and possibly also by heat exchange with a heated flow of an additional refrigerant fluid, thus obtaining a second portion of the pre-cooled hydrogen flow and a third portion of the pre-cooled hydrogen flow.

8. The process of claim 5, wherein said first cooling sub-sub-step A4b) and said first cooling sub-sub-step A5b) are carried out by heat exchange with a liquid and/or cryo-compressed and pumped nitrogen flow, and possibly also by heat exchange with a flow of an additional refrigerant fluid, thus obtaining a second portion of the cooled hydrogen flow and a third portion of the cooled hydrogen flow.

9. The process of claim 5, wherein said one or more further cooling sub-sub-steps A4d) or A5d) are carried out by heat exchange with said additional refrigerant fluid.

10. The process of claim 7, wherein said liquid and/or cryo-compressed nitrogen flow at the first heating level, possibly after a step of heat exchange with said additional refrigerant fluid, is sent to the ammonia synthesis unit for the synthesis of ammonia.

11. The process of claim 6, wherein the liquid and/or cryo-compressed nitrogen used in sub-sub-steps A4a), A5a), A4b) and A5b) is the liquid and/or cryo-compressed nitrogen produced and stored in step B).

12. The process of claim 1, wherein step B) comprises sub-steps of:
B1) subjecting an air flow to combustion in a combustor in the presence of an overall vaporized hydrogen flow, and obtaining a combusted gas flow,
B2) expanding said combusted gas flow, thus obtaining an expanded combusted gas flow,
B3) subjecting said expanded combusted gas flow to a first cooling, thus obtaining an expanded combusted gas flow at a first cooling level,
B4) separating a portion of said the expanded combusted gas flow at the first cooling level and sending it to an ammonia synthesis unit for the synthesis of ammonia,
B5) subjecting the expanded combusted gas flow at the first cooling level to a second cooling step, thus obtaining an expanded gas flow at a second cooling level,
B6) subjecting the expanded gas flow at the second cooling level to a water separation step, thus obtaining a dehydrated combusted gas flow,
B7) optionally separating a first recirculation portion from said dehydrated combusted gas flow, which is joined to the air flow of sub-step B1),
B8) subjecting a second portion separated from said dehydrated combusted gas flow to compression, thus obtaining a compressed dehydrated combusted gas flow,
B9) subjecting said compressed dehydrated combusted gas flow to cooling and at least one water separation step and obtaining a nitrogen flow, and
B10) subjecting said nitrogen flow to condensation, thus obtaining a liquid nitrogen flow, which is sent to a liquid nitrogen tank.

13. The process of claim 12, wherein said step B10) is obtained by using a gaseous hydrogen flow obtained from a gaseous hydrogen tank and a pumped liquid hydrogen flow obtained by pumping a liquid hydrogen flow obtained from a liquid hydrogen tank, thus obtaining a heated gaseous hydrogen flow and a heated vaporized hydrogen flow.

14. The process of claim 13, wherein said liquid hydrogen tank and said gaseous hydrogen tank are the tanks of step A4) and step A5), respectively.

15. The process of claim 13, wherein said heated gaseous hydrogen flow, and said heated vaporized hydrogen flow are sent to step B9), thus obtaining a vaporized heated hydrogen flow and a further vaporized heated hydrogen flow, which are joined in the overall vaporized hydrogen flow used in step B1).

16. The process of claim 15, wherein a portion of said overall vaporized hydrogen flow is sent to the ammonia synthesis unit for the synthesis of ammonia.

17. The process of claim 12, wherein before being sent to the ammonia synthesis unit, said portion of the expanded combusted gas flow at the first cooling level is subjected to one or more compression and cooling cycles for separation of condensed water and is further subjected to compression, thus obtaining a synthesis nitrogen flow.

18. The process of claim 12, wherein a non-condensable flow is obtained from said liquid nitrogen tank, which after compression, thus obtaining a compressed non-condensable flow, is sent together with the overall vaporized hydrogen flow to combustion step B1).

19. The process of claim 1, wherein step B) is a step B′) comprising using a fuel cell.

20. The process of claim 19, wherein an air flow to be subjected to combustion in a combustor according to a step B′1) is preliminarily subjected to a treatment comprising sub-steps of:
b0) possibly filtering by a filter, thus obtaining a filtered air flow,
b1) compressing and obtaining a compressed air flow,
b2) heating and obtaining a compressed and heated air flow, sub-step
b2) comprising sub-sub-steps of:
b2a) heat exchange exchanging in a second exchanger between said compressed air flow and an expanded combusted gas flow, thus obtaining a first heating flow from which a heated integration flow is separated,
b2b) heat exchanging in a third exchanger between said first heating flow and a fifth working fluid, thus obtaining the compressed and heated air flow, and
b2c) heat exchanging in a fourth exchanger between said compressed and heated air flow and a reduced flow output from an anode of the fuel cell, thus obtaining a compressed and further heated air flow,
b3) reducing oxygen contained in said compressed and further heated air flow inside the anode of said fuel cell, thus obtaining said reduced flow, and
b4) cooling said reduced flow, thus obtaining a reduced cooled flow which is joined to said heated integration flow, thus obtaining an integrated flow.

21. The process of claim 20, wherein a combusted gas flow is obtained from said combustion step B′1), which is subjected to the further steps of:
B′2) expanding said combusted gas flow, thus obtaining an expanded combusted gas flow,
B3) cooling said expanded combusted gas flow and obtaining a cooled expanded combusted gas flow,
B′4) separating water and obtaining a nitrogen flow,
B′5) separating a first portion of said nitrogen flow and condensing it in an eighth heat exchanger, thus obtaining a liquid nitrogen flow which is stored in a liquid nitrogen, and
B′6) sending a second portion of said nitrogen flow to an ammonia synthesis unit for the synthesis of ammonia.

22. The process of claim 21, wherein step B′5) is obtained by heat exchange with a gaseous hydrogen flow obtained from a gaseous hydrogen tank and with a pumped liquid hydrogen flow obtained by pumping a liquid hydrogen flow obtained from Said a liquid hydrogen tank, thus obtaining a pumped and heated gaseous hydrogen flow and a heated gaseous hydrogen flow, which are joined in an overall vaporized hydrogen flow.

23. The process of claim 22, wherein said gaseous hydrogen flow and said liquid hydrogen flow of step B′5) are produced and stored in step A).

24. The process of claim 23, wherein a portion of said overall vaporized hydrogen flow is sent to the ammonia synthesis unit for the synthesis of ammonia.

25. The process of claim 22, wherein said overall vaporized hydrogen flow is sent to the combustion step B′1).

26. The process of claim 21, wherein a non-condensable flow is obtained from said liquid nitrogen tank, which after compression, thus obtaining a compressed non-condensable flow, is joined to an overall vaporized hydrogen flow, thus obtaining a flow to be sent to the combustor for step B′1).

27. The process of claim 21, wherein step B′5) is carried out using the hydrogen in liquid and/or gaseous form produced and stored in step A).

28. The process of claim 11, wherein the liquid and/or cryo-compressed nitrogen used in sub-sub-steps A4a), A4b), A5a) and A5b) is the liquid and/or cryo-compressed nitrogen produced and stored in step B) or B′).

29. A plant comprising a liquid and/or cryo-compressed nitrogen tank, a liquid hydrogen tank, a gaseous hydrogen tank, an ammonia synthesis unit for the synthesis of ammonia with a working fluid circuit, an air compressor, a combustor for subjecting an air flow to combustion a gas turbine with a generator or an expander for generating electricity and possibly a further turbine in the working fluid circuit of the ammonia synthesis unit connected to a generator for further generating electricity, and heat exchangers for heat exchange between a liquid nitrogen flow withdrawn from said liquid and/or cryo-compressed nitrogen tank and intended for said ammonia synthesis unit and a liquid and gaseous and/or cryo-compressed hydrogen flow intended for said liquid hydrogen tank and said gaseous hydrogen tank and obtained from water electrolysis, or for heat exchange between a nitrogen flow intended for said liquid and/or cryo-compressed nitrogen tank and obtained from a combusted gas flow and a liquid and/or gaseous hydrogen flow withdrawn from said liquid hydrogen tank or gaseous hydrogen tank.

30. The plant of claim 29, wherein the process of claim 1 is carried out in said plant.
